(19) United States
(12) Patent Application Publication
(10) Pub. No.: US 2016/0210429 A1
(43) Pub. Date: Jul. 21, 2016

(54) SYSTEMS AND METHODS FOR MEDICAL PATIENT TREATMENT TRACKING, PROVIDER-PATIENT ASSOCIATION, AND RECORD INTEGRATION

(71) Applicants: Luis M. Ortiz, Albuquerque, NM (US); Drew W. Alexander, Dallas, TX (US); Kermit D. Lopez, Albuquerque, NM (US)

(72) Inventors: Luis M. Ortiz, Albuquerque, NM (US); Drew W. Alexander, Dallas, TX (US); Kermit D. Lopez, Albuquerque, NM (US)

(21) Appl. No.: 14/988,130

(22) Filed: Jan. 5, 2016

Related U.S. Application Data
(60) Provisional application No. 62/110,321, filed on Jan. 30, 2015.
(60) Provisional application No. 62/099,730, filed on Jan. 5, 2015.

(51) Int. Cl. G06F 19/00; H04L 29/06

(52) U.S. Cl. CPC G06F 19/3406; G06F 19/322; H04L 63/10; H04L 63/0861

(57) ABSTRACT

Wearable devices can be used to associate patients with healthcare providers, within and outside of a healthcare facility. Wearable devices and transponders can be used to track patient location within a facility and determine when a healthcare provider is within close proximity to a patient to provide record access, track and record treatment, and authorize treatment. A patient profile stored in a server can associate patients and healthcare providers. Treatment notifications can be provided to health care providers authorized to receive electronic notifications when a patient receives subsequent treatment at a facility or by a new and/or unregistered healthcare provider. Notification lists can be stored in the patient profile accessible via the server when a patient is admitted for treatment at a treatment facility.

The present invention claims priority as a continuation from U.S. Provisional Patent Application Ser. No. 62/110,321, filed Jan. 30, 3015, entitled “Systems and Methods for Medical Patient and Treatment Tracking, Provider-Patient Association, and Record Integration”, which is herein incorporated by reference in its entirety. The present invention also claims priority as a continuation from U.S. Provisional Patent Application Ser. No. 62/099,730, filed Jan. 5, 2015, entitled “Systems and Methods for Medical Patient and Treatment Tracking, Provider-Patient association, and Medical Record Integration”, which is also herein incorporated by reference in its entirety.

### TECHNICAL FIELD

The disclosed embodiments are generally related to electronic medical records, electronic health records, electronic medical/healthcare management, and wearable computing devices, such as, for example, digital wristbands, for use in healthcare and fitness. Embodiments are additionally related to the field of wireless communications including the use of wearable computer devices, facility-based transponders, user authentication, data access and data tracking. More particularly, embodiments are related to systems and methods utilizing wireless networks, servers, beacons, and portable computers to associate patients, health/medical care providers and health/medical records needed for providing medical treatment, tracking and recording patient treatment, tracking and recording patient progress, association/authentication of interested parties, providing notification to providers of subsequent patient treatment, and medical and health record data management.

### BACKGROUND OF THE INVENTION

The following published United States patent applications are incorporated by reference herein for their teachings in their entireties given the provisional nature of the present application, not because they teach specifically teach the patent eligible aspects of the present invention as ultimately claimed by the inventors, but because the references provide technical background and support as required under 35 USC 112 for various independent features of the present invention, and shall be included in an information disclosure statement filed with the USPTO upon filing of a nonprovisional patent application publications: 20140142396; 20140143064; 20140258208; 20140297642; 20140361147; 20140365214; 20150003214; 20150005912.

Wearable computing devices (“wearable devices”) come in a variety of implementations and configurations. For example, some wearable computing devices are implemented in the context of wristwatch type devices and others are configured in the context of optical head-mounted display (OHMD) devices (e.g., head gear), such as, for example, a head wearable device implemented in the context of eyeglasses. OHMD can display information for a wearer in a smartphone-like hands free format capable of communication with the Internet via, for example, natural language voice commands. Fitness wristbands are in use to track user activity and provide feedback data to users. Smart watches are now available that provide the functionality of smartphones and tablet, but in a smaller user interface wearable on a user's wrist. Additional activity and medical monitoring devices can be mounted on a user's body and can be used to monitor/track patients and assist with treating medical conditions, such as monitors used to measure insulin in the treatment of diabetes.

Some of the main features of wearable computers are in the ability for them to achieve and maintain data currency and consistency. There is a constant interaction between the portable, wearable computer and its user, i.e. there is no need to turn the device on or off. Another feature is the ability to multi-task. It is not necessary to stop what you are doing to use the device; it is augmented into all other actions. These computer devices can be incorporated by the user to act like a prosthetic. It can therefore be like an extension of the user's mind and/or body.

Tablet computers are also currently in use within healthcare environments, such as hospitals. HD's can now be used in place of or to augment tablet computers during treatment. In some implementations of an OHMD device, a touchpad may be located on the side of the device, allowing a user to control the device by swiping through a timeline-like interface displayed on a separate screen in direct view of a user's eye. Sliding backward can show, for example, current events, such as weather, and sliding forward, for example, can show past events, such as, phone calls, photos, updates, etc. Some implementations of a tablet computer or an OHMD may also include the ability to capture images (e.g., take photos and record video). While video is recording, the display screen may stay on. An example of an OHMD wearable device is the Google Glass device.

Electronic records (ER) associated with healthcare include Electronic medical records (EMR) and electronic health records (EHR). ERs continue to displace manual record keeping because of the ubiquity of electronic data storage solutions that are more accessible from remote servers, yet secure. ERs are significantly growing is use outside of healthcare facilities given the need to monitor the healthcare and progress of home-based patients. Despite the growing ubiquity of ERs for recording action on or in association with a patient, there is still a growing need to assure security, provider access to timely information, and access control.

What is needed in the health care and medical fields are systems and methods that can provide enhanced patient monitoring within and outside of facilities as part of ER management programs. What is also needed are systems and methods to associate health care providers and patients during treatment to assure treatment accuracy, treatment history recording, minimize mistakes and provide data for complete ERs and enable audits as needed. What are needed are methods and systems that can also associate patients with providers based on proximity of a provider to a patient during treatment. Systems and methods are also needed that can establish authentication and usage/access levels when healthcare providers become associated with patients and provide for notification of certain providers whenever elective or emergency treatment occurs on a monitored patient.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is therefore an aspect of the disclosed embodiments to provide, inter alia, systems and methods for medical patient and treatment tracking, provider-patient association, and medical record integration.

It is therefore an aspect of the disclosed embodiments that a wrist beacon be provided as wearable device on patients admitted to a treatment facility. The wrist beacon can provide a unique patient identification code, maintain access to a facility wireless network, enable patient location determination, and enable recording of health care provider interaction based on proximity.

It is another aspect of the disclosed embodiments to enable authentication of healthcare providers when in close proximity to a patient for purposes of recording the rendering treatment, maintaining updated treatment records within a secure server, and providing access to records to authorized healthcare providers. Authorization and association of healthcare providers when they are in close proximity to a patient can be provided via wireless signals (e.g., Bluetooth, NFC, RAD, Wi-Fi) from any combination of wearable device, portable computers (e.g., tablets, smartphones), and can include the use of biometrics upon initiation of treatment or records access requests. Biometrics can be provided in the form of voice, fingerprint and eye scan (e.g., can be provided as a image captured by a camera associated with the headgear of at least one of a users eyes, wherein the camera faces inward toward at least one of a user's eyes).

It is yet another aspect of the disclosed embodiments to provide for a wearable devices that can be integrated as beacons or with beacons (e.g., transponders) within a health care facility to associate patients with health care providers, record interactions between health care providers and patients, and create records of treatment and provide and control access to patient records. With such a system, services are capable of being wirelessly communicated between a wearable device and at least one transponder out of a plurality of transponders and dispersed throughout a facility. The at least one transponder can be within at least a Bluetooth range or a Wi-Fi range of communication with said wearable device. The location of a wearable device can be determined via said at least one transponder and based on a proximity of said wearable device to said at least one transponder.

It is yet another aspect of the disclosed embodiments to provide for a wearable device that can be wirelessly read by nearby sensor and/or access a data network and determine a user's location (e.g., patient location within a treatment room simultaneously with doctor's location within same treatment room).

It is also an aspect of the disclosed embodiments to provide security over data communicated with a wearable device. A system and methods can provide an authorized user with data based on the user's identity and location as determined by any of a wearable device or portable computer.

A wireless communications module can be integrated in or associated with the wearable device to enable any: tracking, detecting, and communications with networks and transponders as needed to access data and manage data.

It still another aspect of the disclosed embodiments to provide for a method of determining the location of a user within a facility using radio frequency transponders in near communication (e.g., Bluetooth, WiFi, RFID, NFC, etc.) with a wearable device, and authenticating the healthcare provider/user via RF signatures and/or biometric attributes.

It is also a feature of the present invention that users of a wearable device can be authenticated via at least one biometric associated with the user and via a biometric scanner associated with the wearable device. Data and/or services can be displayed and/or provided via a user interface of the wearable device, in response to authenticating the user via the biometric scanner. Authentication of the user can involve determining the identity of the user and providing the user access to the data and/or the services based on at least one of the identity of the user and access level of the user. Such a biometric scanner can be, for example, a retinal scanner, an iris recognition scanner, a voice recognition scanner, a fingerprint recognition device, or, for example, an ear acoustical scanner for biometric identification using acoustic properties of an ear canal.

It is another feature of the present invention that authentication can be facilitated by, for example, a remote server. The data and/or the services accessed based on the identity of the user can be retrieved from a remote server.

It is yet another feature of the present invention that the wearable device can be associated with a wireless hand held communications device. The data and/or the services can be wirelessly communicated between the wearable device and the wireless hand held communications device (e.g., via Bluetooth communications, RFID, NFC, WiFi, etc.). The wireless hand held communications device can be authenticated based on, for example, the at least one biometric. Additionally, data and/or services can be wirelessly communicated between the wearable device and at least one transponder out of a plurality of transponders dispersed throughout a venue. In general, the at least one transponder may be within at least NFC (near field communications) range and up to RFID, Bluetooth or WiFi range, communication with the wearable device.

It is also a feature to provide updated data that can be wirelessly delivered and/or wirelessly provided to the wearable device with respect to the at least one transponder based on the authenticating the user via the wearable device. The data can be, for example, past medical treatments (e.g., past surgeries, therapies, prescriptions), current medical treatments (e.g., current prescriptions), future medical treatments (scheduled procedures), and health maintenance information (e.g., fitness history/progress).

In an embodiment, such data may be medical data. In the case, the user can be authenticated as a medical provider authorized to receive the medical data based on a location of the user near the at least one transponder located in association with a patient for which the medical data is provided. The wearable device can enable the medical provider to record a medical procedure as video via a camera integrated with the wearable device and also create medical annotations while treating the patient. Such annotations may be, for example, voice annotations recorded by a microphone associated with the wearable device. The annotations and the video can be securely stored in a server as a medical record in association with the patient and is only available for subsequent retrieval by authorized medical providers. A transponder located in association with a patient to determine location of the medical provider assures that accurate access and data association is maintained should a patient be moved around, wherein movement can be tracked by sensors deployed throughout a facility that the patient is within.

In yet another feature, a user profile can be established with respect to a user authenticated by a system to establish an access level with respect to the user for access to the data and/or the services.

It is yet another feature of the present invention that healthcare providers, such as primary physicians, can be automatically authorized in a patient's profile to be automatically notified when/if a patient associated with the healthcare provider receives treatment (emergency or otherwise) by another or subsequent service provider, at a different or new facility, while on travel, or otherwise, when subsequent treatment is stored in a server containing the patient's records, and the notification can occur electronically via known communication methods (e.g., text, email, automated voice messaging).

It is yet another feature of the present invention that a patient can authorize which healthcare providers are provided access to records, and/or are provided with automated messages of any treatment received by a patient by other associated providers, new providers, facilities, whether treatment is elective or in association with emergency circumstances.

It is yet another feature that the system cam synchronize recording of treatment provided to the patient and the identity of healthcare providers treating the patient between the at least one server and mobile computing devices associated with the healthcare providers as well as other providers or third parties authorized by patient to receive such data (e.g., attorneys involved in a legal matter for the patient). Updates of recorded treatment from the at least one server can occur as a push notification to computers and mobile computing devices associated with the healthcare providers.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description herein, serve to explain the principles of the disclosed embodiments.

FIG. 1 illustrates a system diagram of devices interacting in accordance with carrying out aspects of the present invention;

FIG. 2 illustrates features of a wearable computing device (e.g., wristband) and features that it can include in accordance with a feature of the present invention;

FIG. 3 illustrates a patient profile that can be stored in a server and devices that can access the profile, and/or be associated with the profile, in accordance with features of the present invention;

FIG. 4 illustrates a system diagram of how a first service provider (e.g., primary) authorized in a patient profile to receive notifications when the patient receives treatment, can receive electronic notifications when the patient receives subsequent treatment (whether elective or emergency) by another healthcare provider or treatment facility after the patients profile is updated in a server via a data network;

FIG. 5 illustrates a system diagram for a healthcare facility wherein transponders and wearable computers can be in operation by patients, healthcare providers to associated patients and healthcare providers and manage data associated with the patient;

FIG. 6 illustrates a high-flow chart of operations depicting logical operational steps of a method for providing data and/or services to a healthcare provider when a wearable computer device worn by a patient is used, in accordance an alternative embodiment;

FIG. 7 illustrates a high-flow chart depicting logical operational steps of a method for providing data and/or services to a healthcare provider when a wearable computer device worn by a patient is used;

FIG. 8 illustrates a high-flow chart depicting logical operational steps of a method for providing data and/or services to a healthcare provider when a wearable computer device worn by a patient is used; and

FIG. 9 illustrates a block diagram of a method for associating a patient identity with a patient profile, recording treatment and notifying authorized healthcare providers when the patient receives subsequent treatment.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the disclosed embodiments. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which disclosed embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention can be embodied as a method, system, and/or a processor-readable medium. Accordingly, the embodiments may take the form of an entirely hardware application, an, entirely software embodiment or an embodiment combining software and hardware aspects all generally referred to herein as a “circuit” or “module.” Furthermore, the embodiments may take the form of a computer program product on a computer-usable storage medium having computer-usable program code embodied in the medium. Any suitable computer readable medium may be utilized including, for example, hard disks, USB Flash Drives, DVDs, CD-ROMs, optical storage devices, magnetic storage devices, etc.

Computer program code for carrying out operations of the disclosed embodiments may be written in an object oriented programming language (e.g., Python, Java, PHP C++, etc.). The computer program code, however, for carrying out operations of the disclosed embodiments may also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer or entirely on the remote computer. In some described scenarios, the wearable device may be connected to sensor deployed throughout a facility and obtain communication to a network and remote server via NFC, RFD, Bluetooth, WiFi, and cellular data communications. In other scenarios, remote server and secured cloud-based storage facilities may be connected to a user's computer through a local area network (LAN) or a wide area network (WAN), wireless data network e.g., Wi-Fi, Wimax, 802.xx, Bluetooth and cellular data communications networks or the connection may be made to an external computer via most third party supported networks (for example, through the Internet using an Internet Service Provider).

Aspects of the disclosed embodiments can be implemented as an “app” or application software that runs in, for example, a web browser and/or is created in a browser-supported programming language (e.g., such as a combination of JavaScript, HTML, and CSS) and relies on a web browser to render the application. The ability to update and maintain web applications without distributing and installing software on potentially thousands of chant computers is a key reason for the popularity of such apps, as is the inherent support for cross-platform compatibility. Common web applications include webmail, online retail sales, online auctions, wikis and many other functions. Such an ‘app’ can also be implemented as an Internet application that runs on smartphones, tablet computers, wearable devices and other computing devices such as laptop and personal computers.

The disclosed embodiments are described in part below with reference to flowchart illustrations and/or block diagrams of methods, systems, and computer program products and data structures according to preferred and alternative embodiments. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

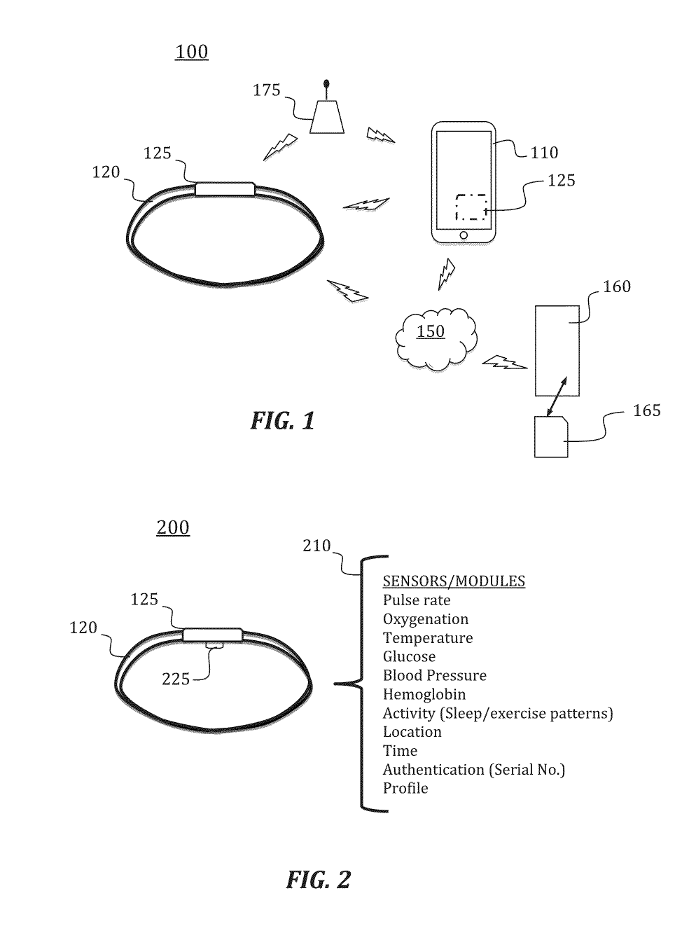

Referring to FIG. 1, a system diagram 100 illustrates aspects of the present invention wherein a remote device 110 used by a healthcare provider may be any type of computing device or transmitter including a laptop computer, a mobile telephone, or tablet computing device, etc., that is configured to communicate data with a wearable computing device 110 worn by a patient. The remote device 110 and the wearable computing device 120 may contain Electronic circuitry 125 to enable the data communication link either directly 140 or via a network 150, or both. Direct communication between a wearable computing device 120 and a remote device 110 in close proximity (which can be determined via close RF communication such as Bluetooth LE) can be supported while either or both devices can also communicate through a network 150 with a remote server 160 for data stored in a patient profile 165 in association with the user (e.g., patient) of the wearable computing device 110, or through transponders 175 located throughout a facility. Electronic circuitry 125 can include modules such as processors, transmitters, receivers, antennas, etc.

Referring to FIG. 2, a wearable computer 200 in the form of a wristband 120 (as also depicted in FIG. 1) is shown. The wearable computer 200 can include at least one sensor 225 in association with the electronics 125 integrated within the wristband 120. A sensor integrated with the wearable computing device in the form of a bracelet can measure, track and record data that can also be accessible by authorized healthcare providers as can be determined by an profile associated with a patient. Features that a wearable computing device 120 can have are listed in the bracket 210 shown in association with the wearable computing device 120. Sensor/module integrated with the wearable computing device can monitor/measure at least one of: pulse rate, oxygenation, temperature, glucose, blood pressure, hemoglobin, activity (e.g., sleep and exercise). The profile can also determine patient location. A patient profile can enable authentication (e.g., via serial number, biometric or passcode) of a user including healthcare providers obtaining access to a patient or the patients data.

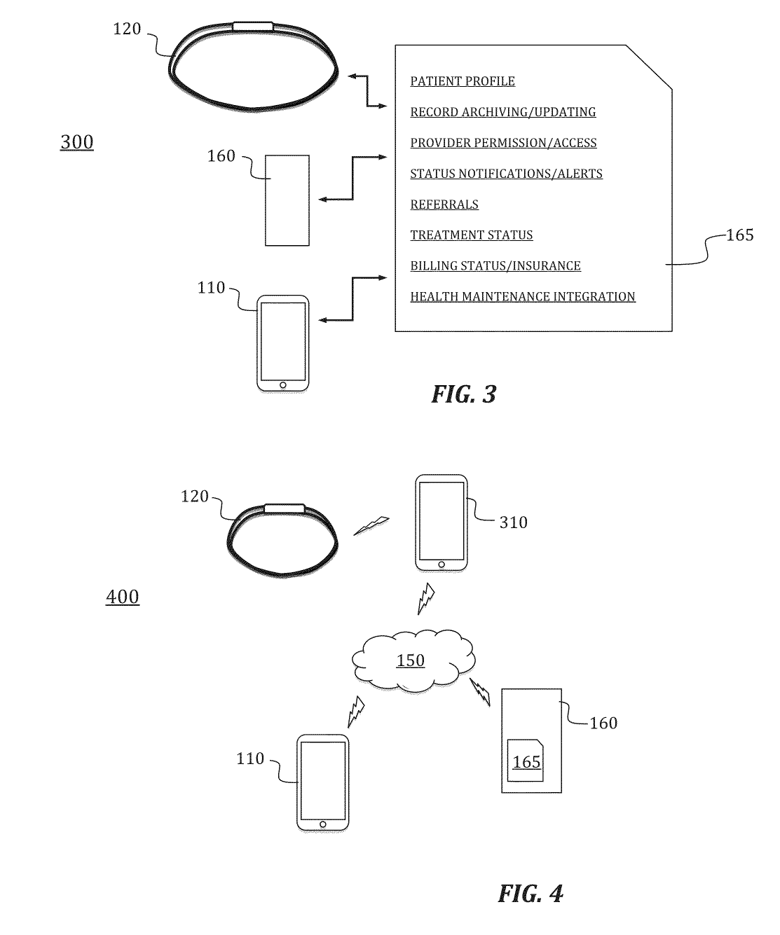

Referring to FIG. 3, a system diagram 300 is depicted with at least three devices (e.g., wristband 120, server 160, and tablet computer/smartphone 110) that can access a patient profile 165. An access profile 210 can archive and update medical records, manage provider permissions an access, track patient treatment for the purpose of providing status notifications to interested healthcare providers, enable designation/archiving or referrals, maintain treatment status, manage billing and insurance records associated with the patient and integrate data into a patient's records that are associated with health maintenance programs. The patient profile 165 can allow for existing service providers to be listed as authorized providers 210 in an electronic template used to authenticate service provider for access to records from the server 160, or receive automated notifications over a data network 150 from the server 160. The template can enable patients to electronically authorize healthcare providers on their profile 210, remove service providers from their access profile 210, and enable notifications. Healthcare providers that are pending authorization can be listed in a pending list within the profile 210 until either the patient or healthcare provider electronically acknowledge and authorize inclusion of the provider on the patient's access profile so that the provider can access records, receive automated notifications, or both. Automated notifications can be provided for elective procedures, emergency procedures, or both. Other variations of access and provider listing can be designed and provided without departing from the intended scope of the featured aspect of a patient access profile 200 as described herein. It is also a feature of the present invention that a patient can authorize non-medical personal to receive notification and access to records. An example of a situation that always presents itself as a need for access and treatment updates is where a patient is represented by an attorney for ongoing litigation in a personal injury matter. Records are required for in order for legal counsel to prepare the patient's demand to insurance companies and in preparation for litigation; yet law firms often encounter difficulty and delays in obtaining health care records. Counsel for patients are already bound by confidentiality and can be authorized access as a third party at the discretion and authorization of a patient if a system as described herein is modified to enable such access.

Referring to FIG. 4, a network diagram is illustrated to depict how a healthcare provider using a computer 110 and associated with a patient using a wearable computing device 120 can receive updated treatment notifications from a server 160 when new treatment (e.g., elective or emergency) are recorded in the patient's profile and health records 165. A subsequent healthcare provider 310 (or facility) can provide data for recording in a patient's records 165 as a patient receives treatment. Any treatment information can be provided to the notification authorized healthcare provider's computer 110 via the network 150 in coordination with the server 160 after data is recorded by subsequent healthcare providers/facilities providing treatment to the associated patient. The system can synchronize recorded treatment provided to the patient and the identity of healthcare providers treating the patient between the at least one server and mobile computing devices associated with the healthcare providers as well as with other providers or third parties authorized by patient to receive such data. Updated treatment records from the at least one server can be provided as a push notification to the computer and/or mobile computing devices associated with the healthcare providers and registered with the patient profile.

As mentioned above, a wearable computer 129 includes electronic circuitry 125, which can further include a wireless communications module (such as cellular, short-range wireless (e.g. Bluetooth, RFID, NFC), or Wi-Fi circuitry) for connection to remote devices (e.g., server 160, transponders 175 and other computing devices 110). It is known that a microprocessor controls all functions (e.g., display, communications, input) in computers. It is also generally known that a wearable computer can further includes a rechargeable power source, such as a battery to power the other circuitry.

The communication link is illustrated as a wireless connection; however, wired connections can also be used. For example, the communication link 30 may be a wired serial bus such as a universal serial bus or a parallel bus. A wired connection may be a proprietary connection as well. The communication link can also be a wireless connection using, e.g., Bluetooth™ radio technology, communication protocols described in IEEE 802.xx (including any IEEE 802.11 revisions), Cellular technology (such as GSM, CDMA, UMTS, EVDO, WiMAX, or LTE), or Zigbee™ technology, among other possibilities such as near field communications (NFC) and RFID. The remote device 20 and/or remote server 60 can be accessible via the Internet/Intranet and may include an accompanying smartphone handheld device, a tablet computer, and a computing cluster associated with a particular data services (e.g., electronic medical/health record access and management).

The wearable computing device 120 can also include one or more connection contacts that can be used to connect device 120 to a power source to recharge a battery without removal thereof. Alternative charging functionality can be incorporated into the wearable device, such as electromagnetic recharging, or motion-based electromagnetic charging. Further, the wearable computing device 120 can include a connection port (e.g. USB) that can be used to connect the wearable computing device 10 directly to an external device such as a smartphone or a computer. Port and contacts can be combined as any standardized connection type port such as USB, fire-wire, thunderbolt, or can be provided as specialized connections.

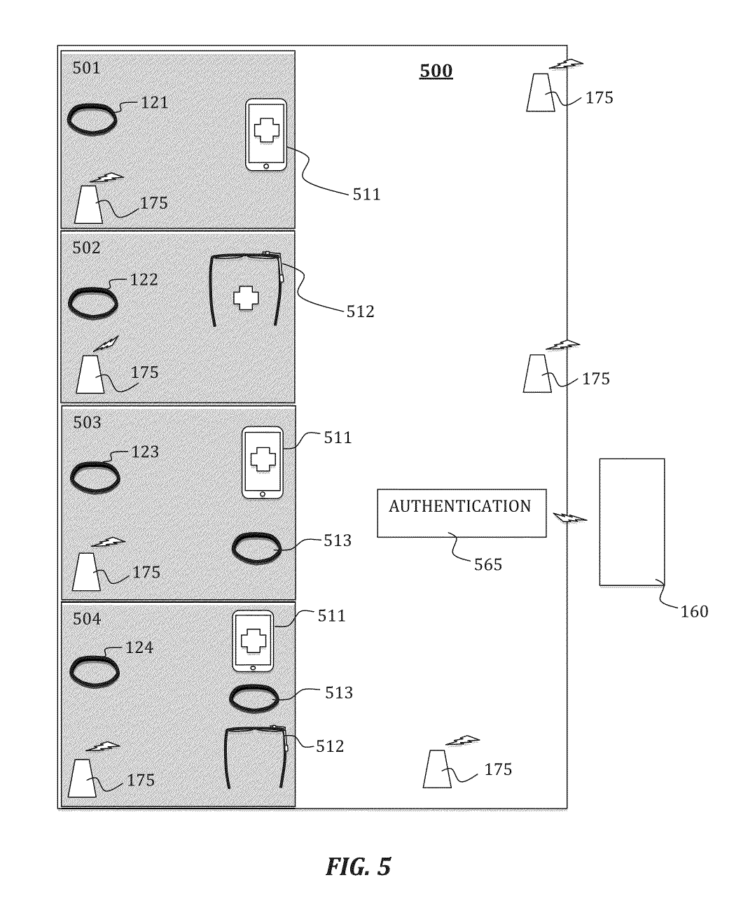

FIG. 5 illustrates an exemplary floor plan for a facility 500. A typical healthcare facility includes treatment rooms 501-504 wherein a patient will meet a healthcare provider (e.g., a doctor, nurse or specialist). A wireless network is typically provided within the facility 500, and at least one secure server 160 is typically accessible by healthcare providers via the wireless network in order to become authenticated 565 with the system and to facilitate record retrieval, patient association and the provision of treatment. In view of features of the present invention, and as shown in room 501, a healthcare provider can use a portable computer 511, such as a tablet computer, when treating a patient wearing a wearable computing device 121. A transponder 175 or access point can facilitate data communication within the room 501, as well as help in determining patient and healthcare provider locations within the facility 500. A healthcare provider can also use a head mounted computer 512 when treating a patient wearing a wearable computing device 122, as shown in room 502. In room 503, a healthcare provider can use a wearable computing device 513, similar to the wearable computing device 503 worn by the patient, in order to become associated with the patient and determine proximity to the healthcare provider to the patient. Proximity can be determined by wireless communication (e.g., NFC. RFID, Bluetooth, WiFi, Cellular, etc.). Bluetooth LE (low energy) a viable communications standard and technology that can support most functions required for this feature, but other standards cannot be ignored.

The wearable computing device 513 worn by the healthcare provider can also be in communication with the portable computer 513 used by the healthcare provider so that records can be viewed or created in association with the patient once the system associated (e.g., authenticate/authorizes access) between the patient and the healthcare providers based on identities associated with their respective wearable devices 513/513. Then, as shown in room 504, a healthcare provider can utilize all forms of technology during treatment (a wearable computer 513, tablet computer 511 and head-mounted computer 512). The healthcare providers can use a wearable computing device 513 to become associated with a patient's wearable computing device 124 when in close proximity, and can view records associated with the patient on a portable computer (e.g., tablet). Headgear with a camera and speaker can also be used in association with the wearable computing device that is providing access to create treatment records that include video and audio, or for viewing records aside from any display provided on the portable computer 511.

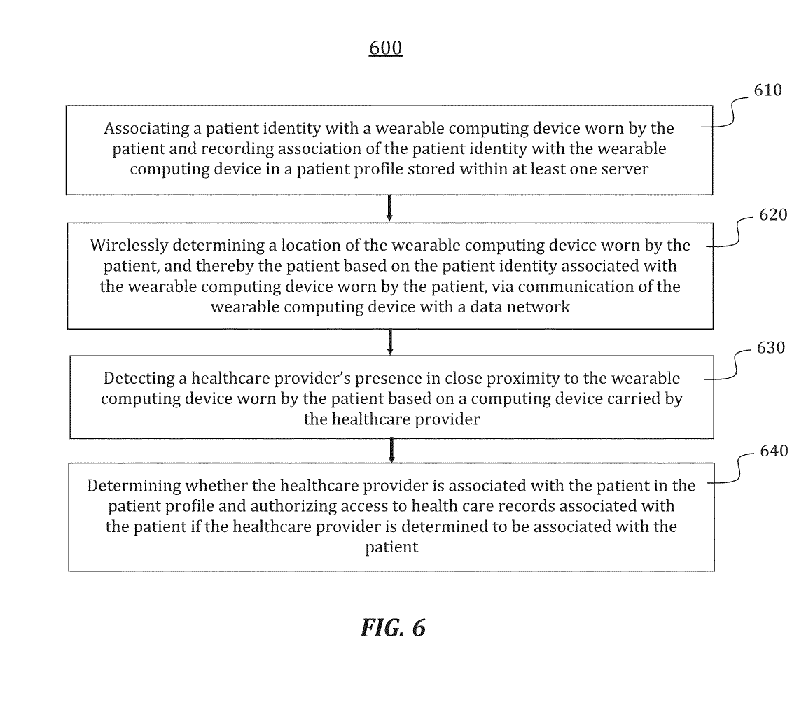

Referring to FIG. 6, a high-level flow chart is shown of a method 600 for associating patients with healthcare providers and providing data and/or services to healthcare providers associated with patients, in accordance with features of the present invention. The method is for providing data and/or services to wearable devices. As shown in Block 610, a patient identity is associated with a wearable computing device worn by a patient and the association of the patient identity with the wearable computing device is recorded in a patient profile stored within at least one server. Then as shown in Block 620, location of the wearable computing device worn by the patient, and thereby the patient, is wirelessly determined based on the patient identity associated with the wearable computing device worn by the patient, via communication of the wearable computing device with a data network. As shown in Block 630, a healthcare provider's presence in close proximity to the wearable computing device worn by the patient is then detected based on a computing device carried by the healthcare provider. Then, as shown in Block 640, it is determined whether the healthcare provider is associated with the patient in the patient profile and is authorized access to health care records associated with the patient if the healthcare provider is determined to be associated with the patient.

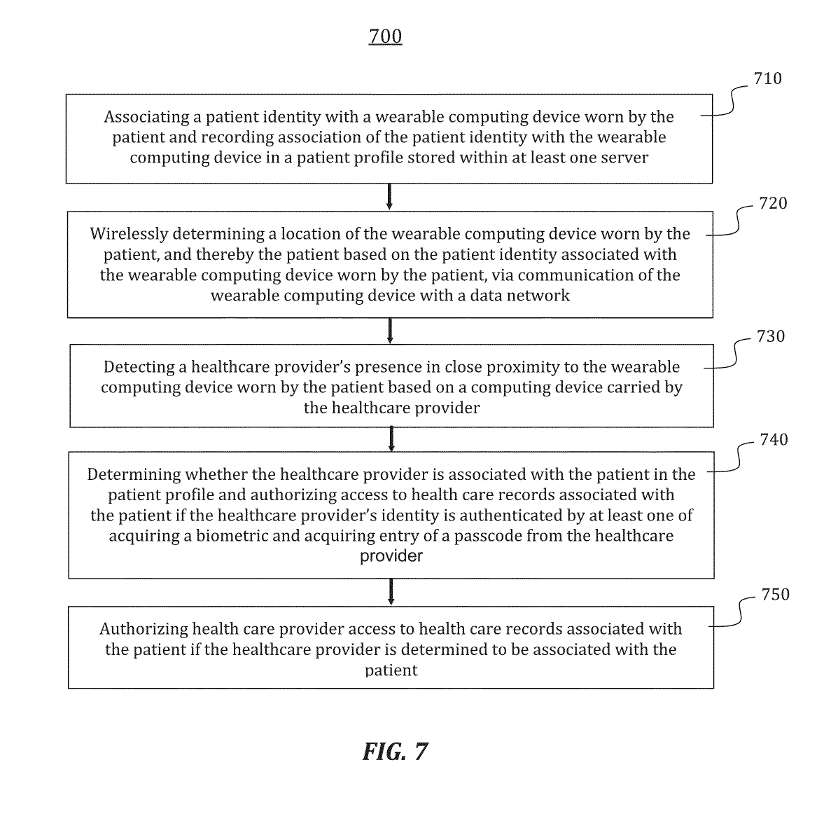

Referring to FIG. 7, a high-level flow chart is shown of a method 600 for associating patients with healthcare providers and providing data and/or services to authenticated healthcare providers, in accordance with features of the present invention. As shown in Block 710, a patient identity is associated with a wearable computing device worn by a patient and the association, of the patient identity with the wearable computing device is recorded in a patient profile stored within at least one server. Then as shown in Block 720, location of the wearable computing device worn by the patient, and thereby the patient, is wirelessly determined based on the patient identity associated with the wearable computing device worn by the patient, via communication of the wearable computing device with a data network. As shown in Block 730, a healthcare provider's presence in close proximity to the wearable computing device worn by the patient is then detected based on a computing device carried by the healthcare provider. Then, as shown in Block 740, it is determined whether the healthcare provider is associated with the patient in the patient profile and is authorized access to access health care records associated with the patient if the healthcare provider is determined to be associated with the patient and the healthcare provider's identity is authenticated by at least one of acquiring a biometric and acquiring entry of a passcode from the healthcare provider.

The aforementioned authenticating step shown in block 740 can further include a step or logical operation for determining the identity of the user and providing the user access to the data and/or the services based on the identity of the user. Examples of data are, for example, coupons, advertising information, video, video clips, replays, statistics, information, text, voice, etc. Examples of services are, for example, tour guides (self guided tours), providing historical information with respect to a point of interesting, providing entertainment information (e.g., voice, text, etc.) to fans at a sporting or concert event, providing medical data and patient monitoring during, for example surgery, treatment and recovery. Other examples of services include providing assistance to drivers to prevent fatigue and auto accidents, and directional and navigational information to drivers.

A biometric scanner can be integrated with an optical and image-processing system associated with the wearable device and/or can be implemented as an “app” that enables the wearable device to perform biometric scanning (recognition) operations. The wearable device can be implemented as head gear worn by a user. Examples of such headgear include, for example, eyeglasses or a hardware system configured in the form of virtual reality gaming goggles worn by the user.

In accordance with another feature, the aforementioned at least one biometric may be, for example, a retinal scan gathered through optics integrated with the wearable device. In yet another embodiment, the at least one biometric can include at least one other biometric gathered through the wearable device. The wearable device may be implemented as data enabled eyewear. Additionally, in some embodiments, the aforementioned authenticating step shown in block 740 can be facilitated by a remote server (e.g. a server or group of servers). The data and/or the services can be accessed and retrieved from such a remote server based on the identity of the user.

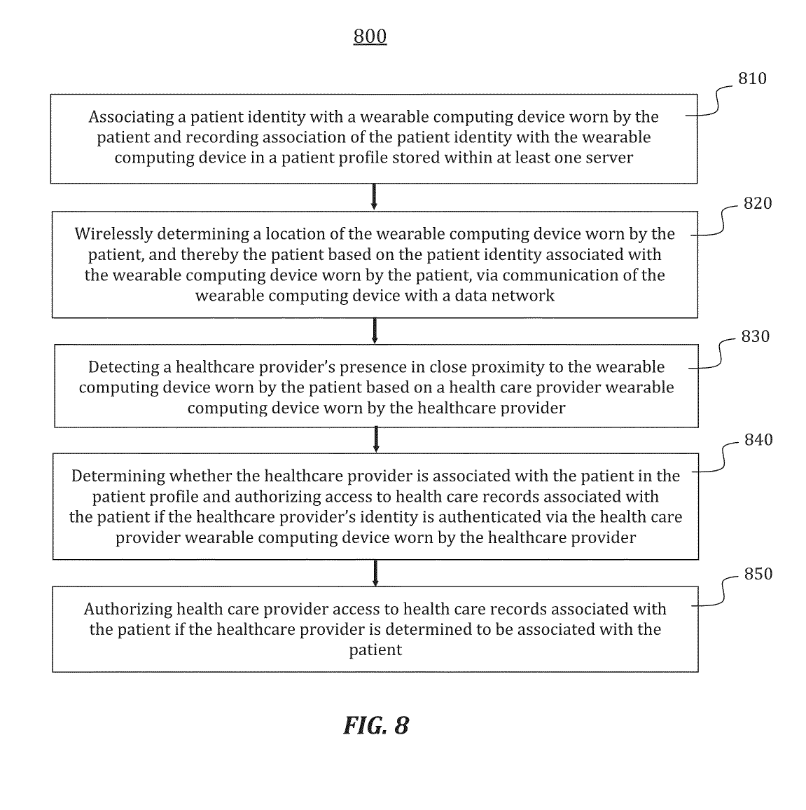

Referring to FIG. 8, a high-level flow chart is shown of a method 800 for associating patients with healthcare providers and providing data and/or services to authenticated healthcare providers, in accordance with features of the present invention. As shown in Block 810, a patient identity is associated with a wearable computing device worn by a patient and the association of the patient identity with the wearable computing device is recorded in a patient profile stored within at least one server. Then as shown in Block 820, location of the wearable computing device worn by the patient, and thereby the patient, is wirelessly determined based on the patient identity associated with the wearable computing device worn by the patient, via communication of the wearable computing device with a data network. As shown in Block 830, a healthcare provider's presence in close proximity to the wearable computing device worn by the patient is then detected (e.g., via Bluetooth, RFD, NFC, etc.) based on a healthcare provider wearable computing device worn by the healthcare provider. Then, as shown in Block 840, it is determined whether the healthcare provider is associated with the patient in the patient profile and is authorized access to access health care records associated with the patient if the healthcare provider is determined to be associated with the patient and the healthcare providers identity is authenticated via the health care provider wearable computing device worn the by the healthcare provider. Finally, as shown in Block 850, the health care provider is authorized to access health care records associated with the patient if the healthcare provider is determined to be associated with the patient.

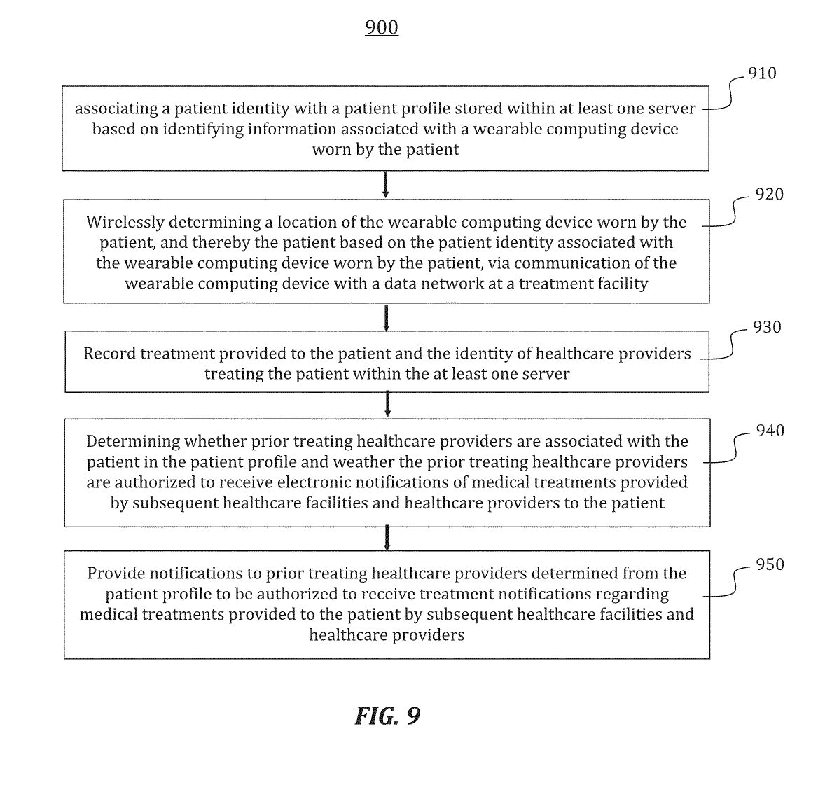

Referring to FIG. 9, illustrated is a flow diagram 900 for a method of providing treatment alerts to service providers registered within a patient profile. As shown in Block 910, a patient identity become associated with a patient profile stored within at least one server based on identifying information associated with a wearable computing device worn by the patient. Then as shown in Block 920, a location of the wearable computing device worn by the patient, and thereby the patient is wirelessly determined based on patient identity associated with the wearable computing device worn by the patient, via communication of the wearable computing device with a data network at a treatment facility. Treatment provided to the patient and the identity of healthcare providers treating the patient within the at least one server is then recorded, as shown in Block 930. As shown in Block 940, it can then be determined whether prior treating healthcare providers are associated with the patient in the patient profile and weather the prior treating healthcare providers are authorized to receive electronic notifications of medical treatments provided by subsequent healthcare facilities and healthcare providers to the patient. Finally, as shown in Block 950, notifications are provided to prior treating healthcare providers determined from the patient profile to be authorized to receive treatment notifications regarding medical treatments provided to the patient by subsequent healthcare facilities and healthcare providers.

Authentication can be provided for wirelessly communicating data and/or services between the wearable device and at least one transponder out of a plurality of transponders and dispersed with a venue. The at least one transponder is preferably within wireless communications range (e.g., Bluetooth LERFID, NFC) of the wearable device. One example of a transponder that can be implemented in accordance with one or more embodiments is the “iBeacon.” iBeacon is the trademark [for the proximity system that Apple Inc. has referred to as “a new class of low-powered, low-cost Bluetooth transmitters that can notify nearby iOS devices of their presence.” The technology enables an iOS device or other hardware to send push notifications to iOS devices in close proximity. Devices running the Android operating system, for example, can receive iBeacon advertisements but cannot emit iBeacon advertisements (i.e., central role only). Currently, the iBeacon operates on Bluetooth Low Energy (BLE), also known as Bluetooth Smart. BLE can also be found on Bluetooth 4.0 devices that support dual mode. iBeacon uses Bluetooth low energy Proximity sensing to transmit a universally unique identifier capable of being picked up by a compatible app or operating system that can be turned into a physical location or trigger an action on the device.

A user can be authenticated as a medical provider authorized to receive the medical data based on a location of the user near the at least one transponder located in association with a patient for which the medical data is provided. A wearable device can enables the medical provider to record a medical procedure as a video via a digital camera (e.g., video cameras) integrated with the wearable device and make medical annotations while treating the patient. Such annotations can be voice annotations recorded by the wearable device. The annotations and the video can be securely stored in a server as a medical record in association with the patient and can be made available for subsequent retrieval by authorized medical providers.

It is a feature of the present invention that the wearable computing device be capable of bidirectional communication with a second screen in order to provide a larger viewing platform of the data and/or the services. The second screen can be a display screen located within viewing proximity of the wearable device. Such a second screen can be, for example, a device such as a display screen of a smartphone, a laptop computer, a tablet computing device, a flat panel television, and a projector.

A system in a large medical facility can include a module within a local server for authenticating the user as a medical provider authorized to receive the medical data based on a location of the user near at least one transponder located in association with a patient for which the medical data is provided. The patient and transponder can be located in a room within a hospital, medical facility, medical clinic, etc. The wearable device enables the medical provider to obtain treatment checklists, obtain treatment guidance, record a medical procedure as video via a camera (e.g., video camera) integrated with the wearable device and make medical annotations while treating the patient. As indicated previously, such annotations can be, for example, voice annotations recorded by the wearable device. The annotations and the video can be securely stored in a server (e.g., a remote server) as a medical record in association with the patient and made available for subsequent retrieval by authorized medical providers. Checklists and health guidance can also be obtained from the server.

Note that in an embodiment, a step or logical operation can be provided for authenticating an identify of the healthcare provider prior to authorizing access to the healthcare records, wherein authentication comprises: at least one of acquiring a biometric; and acquiring entry of a passcode from the healthcare provider; and an RFID tag and/or NFC-enabled credentialed smartcard or worn bracelet that is challenged throughout a healthcare facility (e.g., upon entry into a patient's room, wherein a patient awaits treatment).

It should be appreciated that a system as described herein and its users can also benefit from access to other records associated with a patient. The system enables health care professional to access a patient's medical treatment records; however a primary care physician (PCP) with long-term patient relationship could benefit from having access to a patient's health maintenance records (e.g., records associated with fitness, diet, physical therapy, etc.) as well as educational records. For example, a patient's school records from K-12 may provide additional insight to a therapist working with the emotional or psychiatric needs of the patient. There may be information (e.g., discipline, grade reports, etc.) that can be helpful in indentifying the trigger for a patient's state of mental health. Record form additional training and education may also be considered useful. Records from employees, military, etc. could offer similar insight and benefits to a treating physician.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for providing data associated with a user of wearable devices, said method comprising:
associating a patient identity with a wearable computing device worn by the patient and recording an association of the patient identity with the wearable computing device in a patient profile stored within at least one server that communicates with the wearable computing device;
wirelessly determining a location of the wearable computing device worn by the patient, and thereby locate the patient based on the patient identity associated with the wearable computing device worn by the patient, via communication of the wearable computing device with a data network that communicates with the at least one server;
detecting a presence of a healthcare provider in close proximity to the wearable computing device worn by the patient based on a computing device carried by the healthcare provider;
determining whether the healthcare provider is associated with the patient in the patient profile; and
authorizing access to health care records associated with the patient if the healthcare provider is determined to be associated with the patient.

2. The method of claim 1, including the step of authenticating an identify of the healthcare provider prior to authorizing access to the healthcare records, wherein authentication comprises at least one of: acquiring a biometric from the healthcare provider; acquiring entry a passcode from the healthcare provider; acquiring a signal from an RFID tag and/or NFC-enabled credentialed device carried by the healthcare provider that is challenged throughout a healthcare facility.

3. The method of claim 1, wherein the computing device carried by the healthcare provider comprises a wearable computing device worn by the healthcare provider.

4. The method of claim 3, wherein the wearable computer device worn by the healthcare provider includes a user interface.

5. The method of claim 4, including authenticating the identity of the healthcare provider occurs prior to authorizing access to the healthcare records, wherein authentication is provided by at least one of: acquiring a biometric; and acquiring entry of a passcode from the healthcare provider on the user interface.

6. The method of claim 3, wherein said wearable computing device worn by the healthcare provider comprises an optical head-mounted display.

7. The method of claim 2, further comprising wherein said authenticating is facilitated over the data network by the at least one remote server.

8. The method of claim 7, wherein data and/or services are accessed by the healthcare provider based on the authentication and is retrieved over the data network from the at least one remote server.

9. The method of claim 3, further comprising associating the wearable computing device worn by the healthcare provider with a wireless hand held computer, wherein the wireless hand held computer includes a display screen and user interface for the healthcare provider to review, create and manage records associated with the patient.

10. The method of claim 1, wherein the step of wirelessly determining the location of the wearable computing device worn by the patient is facilitated by at least one transponder out of a plurality of transponders dispersed throughout a healthcare facility.

11. The method of claim 10, wherein the at least one transponder out of a plurality of transponders dispersed throughout a healthcare facility is part of the data network.

12. The method of claim 1, wherein the step of detecting the healthcare provider's presence in close proximity to the wearable computing device worn by the patient based on a computing device carried by the healthcare provider is facilitated by communication of at least one of the wearable computing device worn by the patient and the computing device carried by the healthcare provider with at least one transponder out of a plurality of transponders dispersed throughout a healthcare facility.

13. The method of claim 9, wherein the step of detecting the healthcare provider's presence in close proximity to the wearable computing device worn by the patient based on a computing device carried by the healthcare provider is facilitated by communication of at least one of the wearable computing device worn by the patient, the wearable computing device worn by the healthcare provider and the computing device carried by the healthcare provider with at least one transponder out of a plurality of transponders dispersed throughout a healthcare facility.

14. The method of claim 13, wherein said at least one transponder is within at least one of NFC range, Bluetooth range or WiFi communications range of said wearable device.

15. The method of claim 6, wherein the wearable device enables the medical provider to record a medical procedure as video via a camera integrated with the wearable device and creates medical annotations while treating the patient.

16. The method of claim 15, wherein said annotations comprise voice annotations recorded by a microphone associated with said wearable device.

17. The method of claim 16, wherein said annotations and the video are securely stored in the server as a medical record in association with the patient and are available for subsequent retrieval by authorized medical providers.

18. A system for providing data and/or services in association with wearable devices, said system comprising:
access to at least one server containing medical records and supporting patient-healthcare provider association, authentication and record management;
a patient wearable device associated with a patient admitted to a healthcare facility, wherein patient association is recorded in the at least one server;
healthcare provider wearable devices associated with healthcare providers working at the healthcare facility, wherein healthcare provider association is recorded in the at least one server; and
a data network including a plurality of transponders deployed throughout the healthcare facility, wherein the transponders enable determination of wearable device location the data network facilitates user authentication and access to records;
wherein patient association with a healthcare provider is determined from a patient profile stored on the at least one server when a healthcare provider wearing a provider wearable device is determined by at least one transponder to be in close proximity to a patient wearing a patient wearable device, and the healthcare provider is authorized access to data associated with the patient based on the patient association.

19. The system of claim 18, including a biometric scanner for authenticating healthcare provider identity, said biometric scanner further comprising at least one of: a retinal scanner.

20. The system of claim 19, were said biometric scanner comprises an iris recognition scanner, a voice recognition scanner, a fingerprint recognition device, an ear acoustical scanner for biometric identification using acoustic properties of an ear canal.

21-25. (canceled)
